(19) United States
(12) Patent Application Publication
(10) Pub. No.: US 2014/0344470 A1
(43) Pub. Date: Nov. 20, 2014

(54) METHOD AND APPARATUS FOR STREAMING SERVICE FOR PROVIDING SCALABILITY AND VIEW INFORMATION

(71) Applicant: ELECTRONICS AND TELECOMMUNICATIONS RESEARCH INSTITUTE, Daejeon (KR)

(72) Inventors: Jin Young Lee, Daejeon (KR); Bong Ho Lee, Daejeon (KR); Kug Jin Yun, Daejeon (KR); Won Sik Cheong, Daejeon (KR); Nam Ho Hur, Daejeon (KR); Jae Gon Kim, Goyang (KR); Doo San Baek, Goyang (KR)

(21) Appl. No.: 14/360,174

(22) PCT Filed: Nov. 23, 2012
(86) PCT No.: PCT/KR2012/009978

§ 371 Date: May 22, 2014

(30) Foreign Application Priority Data
Nov. 23, 2011 (KR) 10-2011-0122994
Nov. 23, 2012 (KR) 10-2012-0133477

(51) Int. Cl. H04N 21/236; H04L 29/06

(52) U.S. Cl. CPC H04N 21/236; H04L 65/4069; H04L 65/607
USPC 709/231

(57) ABSTRACT

A method and apparatus for a streaming service to provide scalability and view information are provided. When a scalable video or multi-view video is transmitted using a Moving Picture Experts Group-2 (MPEG-2) system, scalability information or view information regarding the scalable video or multi-view video in a payload may be used. Using the scalability information or view information, a packetized scalable video or multi-view video may be efficiently adapted to various terminal performances, various network characteristics, a specific user preference, and the like.

### TECHNICAL FIELD

The following embodiments relate to a method and apparatus for a streaming service.

A method and apparatus for providing a stream including scalability and view information are provided.

### BACKGROUND ART

A Moving Picture Experts Group-2 (MPEG-2) system may perform a process of packetizing and multiplexing an Element Stream (ES) generated in a video part and an audio part, to store or transmit the ES.

The process may be broadly divided into two operations.

One of the two operations may be performed to generate a Program Stream (PS) to be stored in a storage medium.

The other operation may be performed to generate a Transport Stream (TS) to be transmitted or broadcasted over a network.

When a scalable video is transmitted through a TS of the MPEG-2 system, efficient scalability in a TS level needs to be supported.

In conventional methods, scalability information of a scalable video in a payload of a TS may be identified based on Program Specific Information (PSI).

When the above methods are used, the MPEG-2 system may be periodically synchronized with the PSI, and may analyze the PSI all the time, to use the scalability information.

Additionally, to efficiently use various scalable layers provided in the scalable video, it is inevitable to increase the PSI and an overhead of a Packetized Elementary Stream (PES).

Furthermore, the scalability information of the scalable video in the payload of the TS may be provided from the TS using a Packet Identifier (PID) based on the PSI.

Accordingly, a separate ES needs to be formed for each scalable layer to be identified in the TS level, and a PID needs to be assigned.

To identify various scalable layers in the TS level, a large number of ESs need to be formed. A need to form a large number of ESs may complicate a structure of a TS generator (namely, a multiplexer), and a structure of a TS demultiplexer.

Accordingly, there is a desire to introduce a method of using efficient scalability information in a TS level.

Additionally, digital broadcasting is expected to be developed from current stereo three-dimensional (3D) video broadcasting to Ultra High Definition (UHD) broadcasting, multi-view 3D video broadcasting, and the like. Accordingly, a larger transmission amount in the digital broadcasting may be required.

A conventional MPEG-2 TS packet has a limited size, for example, 188 bytes. Accordingly, a new transmission packet is required to be defined as a packet of an MPEG-2 TS. Researches on a more effective transmission format, compared to a conventional MPEG-2 TS, are required. For example, MPEG Media Transport (MMT) used instead of the conventional MPEG-2 TS may be standardized.

Accordingly, there is a desire to introduce a method for efficiently providing scalability and multi-view video information in the MMT.

### DISCLOSURE OF INVENTION

### Technical Goals

An aspect of the present invention provides an apparatus and method that may provide information regarding a scalable video and information regarding a multi-view video, through a Moving Picture Experts Group-2 (MPEG-2) Transport Stream (TS).

Another aspect of the present invention provides a streaming apparatus and method that may provide information regarding a scalable video and information regarding a multi-view video, through MPEG Media Transport (MMT).

### Technical Solutions

According to an aspect of the present invention, there is provided a streaming server, including: a packet generator to generate a Moving Picture Experts Group-2 (MPEG-2) Transport Stream (TS) packet; and a transmitter to transmit an MPEG-2 TS using the MPEG-2 TS packet, wherein the MPEG-2 TS includes a scalable video stream, and wherein a header of the MPEG-2 TS packet includes scalability information of the scalable video stream.

The scalable video stream may be divided and included in a payload of the MPEG-2 TS packet.

The scalability information may be included in transport private data of the header.

The transport private data may be included in an optional field in an adaptation field of the header.

The header may include a scalability information flag indicating whether the scalability information exists, and a view information flag indicating whether view information of the scalable video stream exists.

The header may include a private data flag indicating whether the scalability information flag and the view information flag exist.

The scalability information may include spatial scalability information of the scalable video stream, temporal scalability information of the scalable video stream, and quality scalability information of the scalable video stream.

The view information may be included in the transport private data of the header.

The packet generator may generate the view information using second view information in a Network Abstraction Layer Unit (NALU) header of a Multi-view Video Coding (MVC).

The packet generator may generate the scalability information using second scalability information in a NALU header of a Scalable Video Coding (SVC).

The packet generator may generate the scalability information only when data of the NALU header is included in the MPEG-2 TS packet.

The packet generator may generate the scalability information in only the MPEG-2 TS packet including the data of the NALU header, among one or more MPEG-2 TS packets having the same Packet Identifier (PID).

The packet generator may include a scalability information inserter to insert the scalability information into the MPEG-2 TS packet.

According to another aspect of the present invention, there is provided a streaming client, including: a receiver to receive an MPEG-2 TS; and a packet processor to process an MPEG-2 TS packet in the MPEG-2 TS, wherein the MPEG-2 TS includes a scalable video stream, and wherein a header of the MPEG-2 TS packet includes scalability information of the scalable video stream.

The packet processor may determine whether the scalability information and view information of the scalable video stream are included in the packet, based on a scalability information flag and a view information flag that are included in the header.

The packet processor may generate, based on the scalability information, scalability information in a NALU header of a SVC.

The packet processor may extract the scalability information, only when data of the NALU header is included in the MPEG-2 TS packet.

The packet processor may extract the scalability information from only the MPEG-2 TS packet including the data of the NALU header, among one or more MPEG-2 TS packets having the same PID.

The packet processor may extract the scalability information of the MPEG-2 TS packet from a second MPEG-2 TS packet of a previous time that includes the scalability information and that is located closest to the MPEG-2 TS packet, among the at least one MPEG-2 TS packet having the same PID.

According to still another aspect of the present invention, there is provided a streaming service method, including: generating an MPEG-2 TS packet; and transmitting an MPEG-2 TS generated using the MPEG-2 TS packet, wherein the MPEG-2 TS includes a scalable video stream, and wherein a header of the MPEG-2 TS packet includes scalability information of the scalable video stream.

Scalable video information, multi-view video information, or scalable multi-view video information may be selectively included in a header of a Media Fragment Unit (MFU).

The header may include combined scalability information of scalable video information, multi-view video information, or scalable multi-view video information, based on layer type information.

According to yet another aspect of the present invention, there is provided a streaming server, including: a processor to generate an MPEG Media Transport (MMT) packet; and a networking unit to transmit an MMT stream using the MMT packet, wherein the MMT packet includes at least one of a multi-view video, a scalable video, and a scalable multi-view video.

An MFU in the MMT packet may include at least one of the multi-view video, the scalable video, and the scalable multi-view video.

A header of the MFU may include a priority identifier (ID).

The priority ID may indicate a priority of a multi-view layer of the multi-view video included in the MFU.

The header of the MFU may include a view ID, an interview prediction flag, and an anchor picture flag.

The view ID may indicate a unique ID of the multi-view video.

The interview prediction flag may indicate whether a current view component is predictable by other view components in a current Access Unit (AU).

The anchor picture flag is used for a random access to the multi-view video.

The header of the MFU may include a priority ID.

The priority ID may indicate a priority of a scalable layer of the scalable video included in the MFU.

The header of the MFU may include a spatial ID, a temporal ID, and a quality ID.

The spatial ID may indicate a spatial level of the scalable video.

The temporal ID may indicate a temporal level of the scalable video.

The quality ID may indicate a quality level of the scalable video.

The header of the MFU may include a priority ID.

The priority ID may indicate a priority of the multi-view scalable video included in the MFU.

The header of the MFU may include a view ID, a spatial ID, a temporal ID, and a quality ID.

The view ID may indicate a unique ID of the scalable multi-view video.

The spatial ID may indicate a spatial level of the scalable multi-view video.

The temporal ID may indicate a temporal level of the scalable multi-view video.

The quality ID may indicate a quality level of the scalable multi-view video.

The header of the MFU may include a layer information flag.

The layer information flag may indicate whether information regarding at least one of the scalable video, the multi-view video and the scalable multi-view video exists.

The header may include information of a layer type of at least one of the scalable video, the multi-view video and the scalable multi-view video exists, through the layer information flag.

The header may include at least one of information of the multi-view video, information of the scalable video, and information of the multi-view scalable video, based on the information of the layer type.

At least one of the scalable video, the multi-view video and the scalable multi-view video may be divided and included in an MFU payload in the MMT packet.

According to a further aspect of the present invention, there is provided a streaming service method, including: generating an MMT packet; and transmitting an MMT stream using the MMT packet, wherein the MMT packet includes at least one of a multi-view video, a scalable video, and a scalable multi-view video.

According to a further aspect of the present invention, there is provided a streaming client, including: a networking unit to receive an MMT stream; and a processor to process an MMT packet in the MMT stream, wherein the MMT packet includes at least one of a multi-view video, a scalable video, and a scalable multi-view video.

An MFU in the MMT packet may include at least one of the multi-view video, the scalable video, and the scalable multi-view video.

A header of the MFU may include a priority ID.

The priority ID may indicate a priority of a multi-view layer of the multi-view video included in the MFU.

The header of the MFU may include a view ID, an interview prediction flag, and an anchor picture flag,

The view ID may indicate a unique ID of the multi-view video.

The interview prediction flag may indicate whether a current view component is predictable by other view components in a current AU.

The anchor picture flag is used for a random access to the multi-view video.

The header of the MFU may include a priority ID.

The priority ID may indicate a priority of a scalable layer of the scalable video included in the MFU.

The header of the MFU may include a spatial ID, a temporal ID, and a quality ID.

The spatial ID may indicate a spatial level of the scalable video.

The temporal ID may indicate a temporal level of the scalable video.

The quality ID may indicate a quality level of the scalable video.

The header of the MFU may include a priority ID.

The priority ID may indicate a priority of the multi-view scalable video included in the MFU.

According to a further aspect of the present invention, there is provided a streaming service method, including: receiving an MMT stream; and processing an MMT packet in the MMT stream, wherein the MMT packet includes at least one of a multi-view video, a scalable video, and a scalable multi-view video.

### Effect of the Invention

According to embodiments, it is possible to provide scalability information in a Transport Stream (TS) level, by extending a TS header, and by inserting the scalability information into the extended TS header.

According to embodiments, it is possible to transmit scalability information and view information using a TS header, without a change in existing syntax and meaning.

According to embodiments, it is possible to reduce an overhead of a TS header by inserting scalability information into only a TS packet header including a Network Abstraction Layer Unit (NALU) header.

According to embodiments, it is possible to provide scalability information, view information, interview prediction flag information, and anchor picture flag information used for a random access, in Moving Picture Experts Group (MPEG) Media Transport (MMT), by inserting scalable video information and multi-view video information into a header of a Media Fragment Unit (MFU) of an MMT packet.

### BRIEF DESCRIPTION OF DRAWINGS

FIG. 1 is a diagram illustrating a configuration of an extended Transport Stream (TS) header according to an embodiment;

FIG. 2 is a diagram illustrating a configuration of an optional field according to an embodiment;

FIG. 3 is a diagram illustrating a syntax defined by extending transport private data of a TS header, to transmit scalability information according to an embodiment;

FIG. 4 is a diagram illustrating a structure of an adaptation field containing transport private data;

FIG. 5 is a diagram illustrating a method of inserting scalability information into a TS header, using scalability information included in a Network Abstraction Layer Unit (NALU) header of Scalable Video Coding (SVC), according to an embodiment;

FIG. 6 is a diagram illustrating a structure of a streaming server according to an embodiment;

FIG. 7 is a block diagram illustrating a structure of a streaming client according to an embodiment;

FIG. 8 is a flowchart of a streaming service method according to an embodiment;

FIG. 9 is a diagram illustrating a Media Fragment Unit (MFU) according to an embodiment;

FIG. 10 is a diagram illustrating a single M-unit case of an M-unit according to an embodiment;

FIG. 11 is a diagram illustrating a fragmented M-unit case of an M-unit according to an embodiment;

FIG. 12 is a diagram illustrating a Moving Picture Experts Group (MPEG) Media Transport (MMT) asset according to an embodiment;

FIG. 13 is a diagram illustrating an MMT package according to an embodiment;

FIG. 14 is a diagram illustrating an MMT PayLoad Format (PL-Format) for a control type packet according to an embodiment;

FIG. 15 is a diagram illustrating an MMT PL-Format for a media type packet according to an embodiment;

FIG. 16 is a diagram illustrating an MMT PL-Format for a control type packet according to an embodiment;

FIG. 17 is a diagram illustrating a first MMT packet according to an embodiment;

FIG. 18 is a diagram illustrating a second MMT packet according to an embodiment;

FIG. 19 is a diagram illustrating a syntax to provide scalable video or multi-view video information according to an embodiment;

FIG. 20 is a diagram illustrating a structure of a streaming server according to an embodiment;

FIG. 21 is a block diagram illustrating a structure of a streaming client according to an embodiment;

FIG. 22 is a flowchart illustrating a streaming service method according to an embodiment; and

FIG. 23 is a diagram illustrating combined scalability according to an embodiment.

### BEST MODE FOR CARRYING OUT THE INVENTION

Reference will now be made in detail to embodiments, examples of which are illustrated in the accompanying drawings, wherein like reference numerals refer to the like elements throughout. The embodiments are described below in order to explain the present invention by referring to the figures.

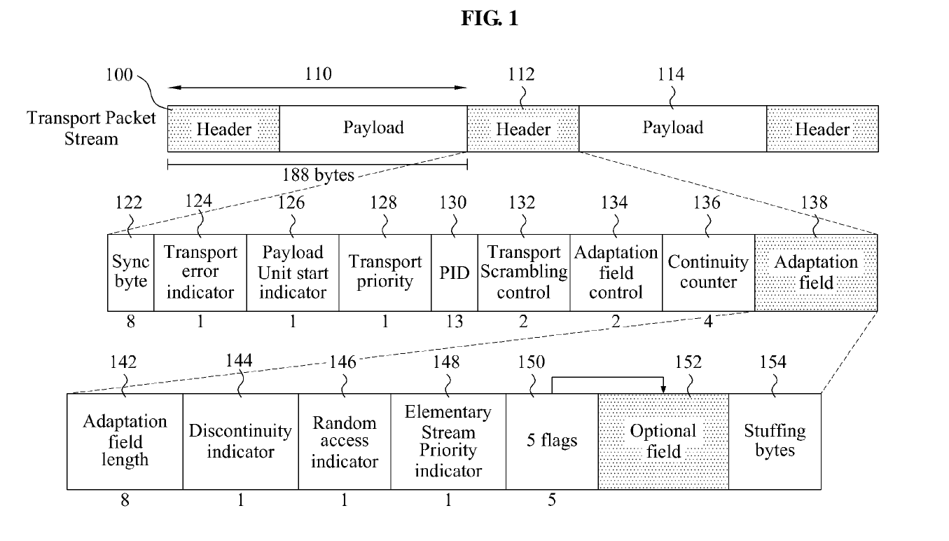

FIG. 1 is a diagram illustrating a configuration of an extended Transport Stream (TS) header 112 according to an embodiment.

A TS packet stream 100 may include a TS packet 110.

The TS packet may include a header 112 (namely, a TS header), and a payload 114.

The TS packet 110 has a fixed length of 188 bytes.

The header 112 may include a sync byte 122, a transport error indicator 124, a payload unit start indicator 126, a transport priority 128, a Packet Identifier (PID) 130, a transport scrambling control 132, an adaptation field control 134, a continuity counter 136, and an adaptation field 138.

A length of each field (namely, bits forming each field) is shown as numerals in a lower part of each field. For example, the sync byte 122 may correspond to 8 bits.

The sync byte 122 may be byte-aligned. Accordingly, when the sync byte 122 is found from the TS 100 through byte alignment, the TS packet 110 may be extracted.

Each TS packet 110 may contain different payloads 114. To identify the different payloads 114, the PID 130 may be included in the header 112.

Additionally, the adaptation field control 134 used to indicate whether a payload exists may be included in the header 112. The adaptation field control 134 may indicate whether the adaptation field 138 exists. The adaptation field control 134 may be included in the payload 114 of the TS packet 110.

The adaptation field 138 may include an adaptation field length 142, a discontinuity indicator 144, a random access indicator 146, an elementary stream priority indicator 148, 5 flags 150, an optional field 152, and stuffing bytes 154.

The 5 flags 150 in the adaptation field 138 may be used to indicate whether a variety of information is included in the optional field 152.

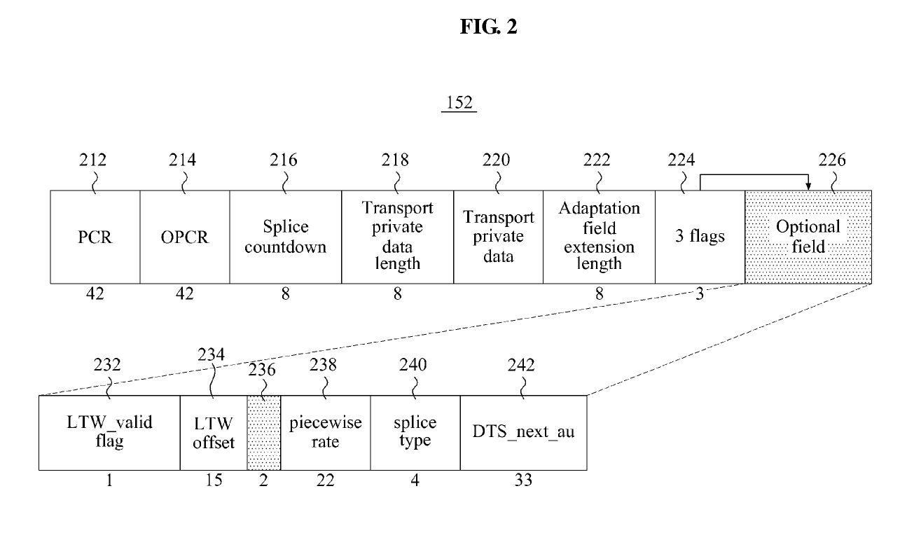

FIG. 2 is a diagram illustrating a configuration of the optional field 152 according to an embodiment.

The optional field 152 may include a Program Clock Reference (PCR) 212, an Original Program Clock Reference (OPCR) 214, a splice countdown 216, a transport private data length 218, transport private data 220, an adaptation field extension length 222, 3 flags 224, and an optional field 226.

In the optional field 152 with respect to the 5 flags 150, the transport private data 220 may be used to transmit data that is not defined in the standard.

When a scalable video is transmitted, scalability information may be inserted into the transport private data 220.

The above-described 5 flags 150 are used to indicate whether the transport private data 220 exists, and accordingly it is possible to determine whether the scalable video is included in the payload 114.

The optional field 226 may include a Legal Time Window (LTW)_valid flag 232, an LTW offset 234, a reserved field 236, a piecewise rate 238, a splice type 240, and a Decoding Time Stamp (DTS)_next_au 242.

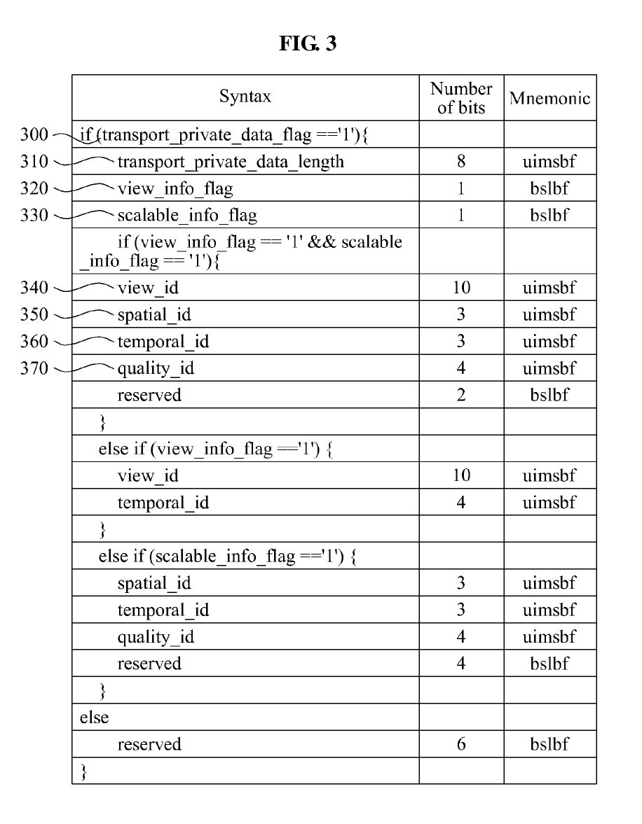

FIG. 3 is a diagram illustrating a syntax defined by extending the transport private data 220 of the TS header 112, to transmit scalability information according to an embodiment.

FIG. 3 illustrates the syntax, a number of bits of each field, and mnemonics, in association with the extended transport private data 220.

When scalability and view information is included in transport private data in a scalable video or multi-view video, existing syntax and semantics of the transport private data may be used without any change, and only the transport private data may be extended and defined as shown in FIG. 3.

Accordingly, a transmitter and a receiver may require a rule to insert scalability information and view information using private data.

A transport_private_data_flag 300 may indicate that a transport_private_data_length 310, a view_info_flag 320, and a scalable_info_flag 330 exist.

The view_info_flag 320 may be used to indicate that view information exists.

The scalable_info_flag 330 may be used to indicate that scalability information exists.

A value of the view_info_flag 320 and a value of the scalable_info_flag 330 may be used to determine which information is to be transmitted, and to determine which information is included.

When both the view_info_flag 320 and the scalable_info_flag 330 have a value of “1,” a view_id 340, a spatial_scalability (or a spatial_id) 350, a temporal_scalability (or a temporal_id) 360, and a quality_scalability (or a quality_id) 370 may be transmitted, and 2 bits may be reserved.

When only the view_info_flag 320 has a value of “1,” the view_id 340 and temporal_id may be transmitted.

When only the scalable_info_flag 330 has a value of “1,” the spatial_id 350, the temporal_id 360, and the quality_id 370 may be transmitted, and 4 bits may be reserved.

When the view_info_flag 320 and the scalable_info_flag 330 have values other than “1,” 6 bits may be reserved.

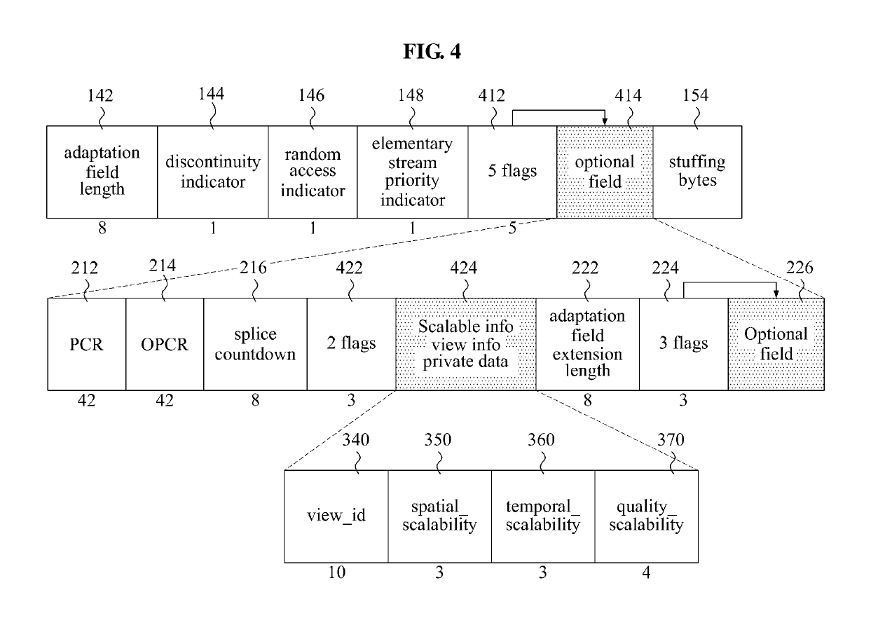

FIG. 4 is a diagram illustrating a structure of the adaptation field 138 containing the transport private data 220.

The TS header 112 generally has a size of 4 bytes, and may transmit required information using the adaptation field 138, as needed.

Within the adaptation field 138, the adaptation field length 142 may represent the total length of the adaptation field 138.

To use the transport private data 220 existing in the adaptation field 138, whether an optional field 414 behind 5 flags 412 is used may be determined using the 5 flags 412.

When a transport private data flag among the 5 flags 412 has a value of “1,” 2 flags 422 in the optional field 414 may determine whether to transmit view info/scalable info/private data 424 through the transport private data 220.

When the view_info_flag 320 has a value of “1,” the view_id 340 may be transmitted.

When the scalable_info_flag 330 has a value of “1,” information of the spatial_id 350, information of the temporal_id 360, and information of the quality_id 370 may be transmitted.

By using the TS header 112 having the above-described structure, scalability information and view information may be transmitted, without a change in the existing syntax and meaning.

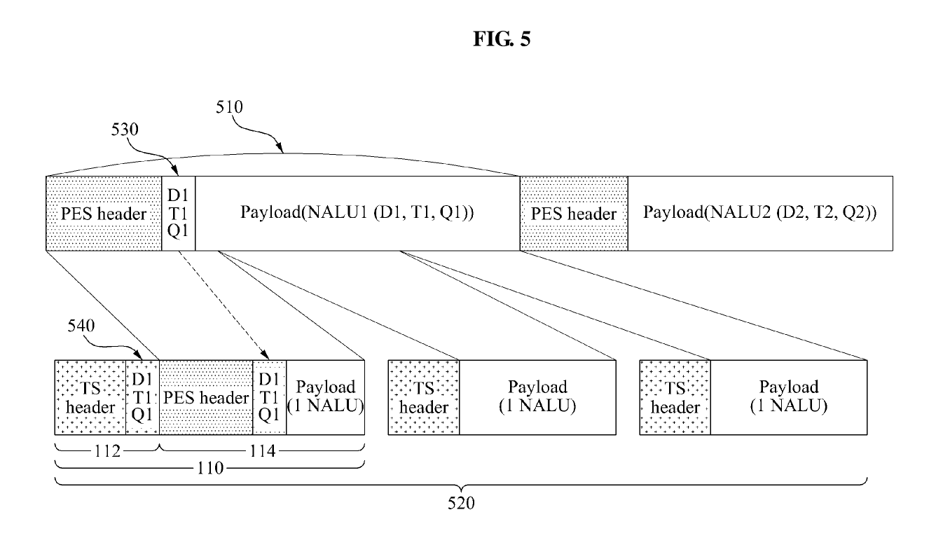

FIG. 5 illustrates a method for inserting scalability information into the TS header 112, using scalability information included in a Network Abstraction Layer Unit (NALU) header of Scalable Video Coding (SVC), according to an embodiment.

The SVC is one of scalable video standards.

Scalability information 540 may include a dependency_id, a temporal_id, and a quality_id. The dependency_id may be represented by D1, D2, and the like, in sequence. The temporal_id may be represented by T1, T2, and the like, in sequence. The quality_id may be represented by Q1, Q2, and the like, in sequence.

A single NALU may be packetized to a Packetized Elementary Stream (PES) 510.

The PES 510 may be packetized into several TS packets 520 having the same PID.

When a single NALU is divided and packetized in several TS packets 110, scalability information of a corresponding NALU may be inserted into the header 112 of each of the TS packets 110.

However, when the scalability information is inserted into all of the TS packets 110, overhead of the TS header 112 may be increased, and overlapping information regarding a single NALU may be inserted.

Accordingly, scalability information may be inserted into only a TS packet header including a NALU header 530, among TS packets having the same PID, rather than into headers of all TS packets. Additionally, the overhead of the TS header 112 may be reduced.

Thus, the scalability information 540 of a corresponding NALU may be inserted into only the header 112 of the TS packet 110, into which the NALU header 530 is inserted into the payload 114.

The above-description of the scalability information 540 of the NALU may also be applied to view information of the NALU. Here, the NALU may be a NALU of Multi-view Video Coding (MVC).

For example, when a single NALU is divided and packetized in several TS packets 110, view information of a corresponding NALU may be inserted into the header 112 of each of the TS packets 110. Additionally, the view information of a corresponding NALU may be inserted into only the header 112 of the TS packet 110, into which the NALU header 530 is inserted into the payload 114.

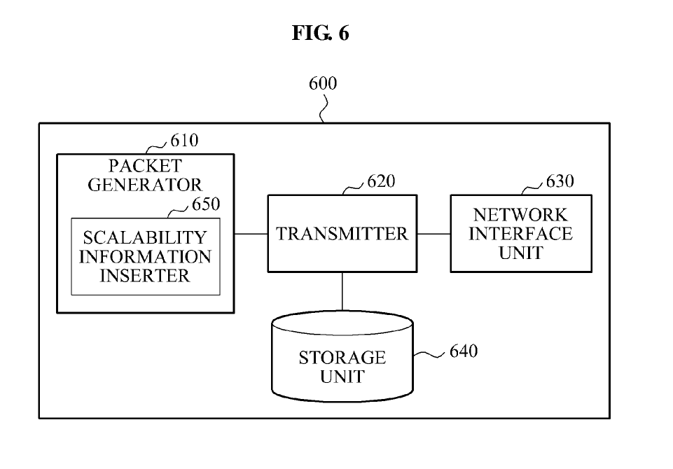

FIG. 6 is a diagram illustrating a structure of a streaming server 600 according to an embodiment.

The streaming server 600 may be an MPEG-2 TS generation apparatus that generates an MPEG-2 TS.

The streaming server 600 may include a packet generator 610, and a transmitter 620.

The packet generator 610 may generate the above-described TS packet 110.

The transmitter 620 may transmit the TS 100 using the TS packet 110. The TS 100 may include a scalable video stream. The scalable video stream may be divided and included in the payload 114 of the TS packet 110. In other words, at least one TS packet 110 forming the TS 100 may include the scalable video stream in the payloads 114.

The transmitter 620 may transmit the TS 100 to a streaming client 700, such as a video player, via a network interface unit 630.

The transmitter 620 may store the TS 100 in a storage unit 640 included in the streaming server 600.

The header 112 of the TS packet 110 may include scalability information of the scalable video stream.

The packet generator 610 may include a scalability information inserter 650.

The scalability information inserter 650 may insert (or add) the scalability information into the TS packet 110 that are already generated.

Accordingly, the above-described scalability information may be generated by the packet generator 610, and may be inserted into the TS packet 110 by the scalability information inserter 650.

The scalability information may be included in the transport private data 220. In other words, the packet generator 610 may generate the scalability information in the transport private data 220. Additionally, to insert the scalability information into the TS packet 110, the scalability information inserter 650 may change the transport private data 220, and other parts of the TS packet 110 that are associated with the transport private data 220.

The packet generator 610 may include the view_info_flag 320 indicating whether the view information of the scalable video stream exists, and the scalable_info_flag 330 indicating whether the scalability information exists. The packet generator 610 may generate the scalable_info_flag 330 and the view_info_flag 320 in the header 112. The scalability information inserter 650 may set the value of the scalable_info_flag 330 based on whether the scalability information exists, and may set the value of the view_info_flag 320 based on whether the view information exists.

The scalability information may be included in the adaptation field 138 in the transport private data 220 of the TS header 112. Additionally, the scalability information may be included in the optional field 152 in the adaptation field 138.

The view information may be included in the adaptation field 138 in the transport private data 220 of the TS header 112. Additionally, the scalability information may be included in the optional field 152 in the adaptation field 138.

The transport_private_data_flag 310 of the TS header 112 may indicate whether the scalable_info_flag 330 and the view_info_flag 320 exist. The packet generator 610 may generate the transport_private_data_flag 310 in the header 112. The scalability information inserter 650 may set a value of the transport_private_data_flag 310 based on whether the scalable_info_flag 330 and the view_info_flag 320 exist.

The scalability information may include at least one of the spatial_id 350, the temporal_id 360, and the quality_id 370.

The packet generator 610 may generate view information, using view information included in the NALU header 530 of the MVC. Alternatively, the scalability information inserter 650 may insert the view information into the TS header 112, using the view information included in the NALU header 530 of the MVC.

Additionally, the packet generator 610 may generate scalability information, using scalability information included in the NALU header 530 of the SVC. Alternatively, the scalability information inserter 650 may insert the scalability information into the TS header 112, using the scalability information included in the NALU header 530 of the SVC.

The packet generator 610 may generate scalability information, only when data of the NALU header 530 is included in the TS packet 110. The scalability information inserter 650 may insert the scalability information into only the TS packet 110 including the data of the NALU header 530.

At least one MPEG-2 TS packet may have the same PID.

The packet generator 610 may generate scalability information in only the TS packet 110 including the data of the NALU header 530 among the at least one MPEG-2 TS packet having the same PID. The scalability information inserter 650 may insert the scalability information into only the TS packet 110 including the data of the NALU header 530 among the at least one MPEG-2 TS packet having the same PID.

Technical information according to the embodiments described above with reference to FIGS. 1 to 5 may equally be applied to the present embodiment and accordingly, a further description thereof will be omitted herein.

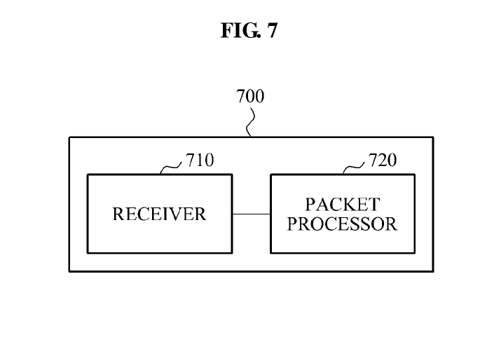

FIG. 7 is a diagram illustrating a structure of a streaming client 700 according to an embodiment.

The streaming client 700 may be a MPEG-2 TS processing apparatus used to process an MPEG-2 TS generated by the streaming server 600.

The streaming client 700 may be an apparatus for receiving and processing the TS 100 generated by the above-described streaming server 600. The TS 100 may include a scalable video stream, and a header of the TS packet 110 may include scalability information of the scalable video stream.

The streaming client 700 may include a receiver 710, and a packet processor 720.

The receiver 710 may receive the TS 100.

The packet processor 720 may process the TS packet 110 in the TS 100.

An operation of the packet processor 720 may correspond to an operation of the packet generator 610.

For example, the packet processor 720 may determine whether scalability information and view information be included in the TS packet 110, based on the view_info_flag 320 in the TS header 112.

Additionally, the packet processor 720 may generate, based on the scalability information, the scalability information included in the NALU header 530 of the SVC.

The packet processor 720 may extract the scalability information, only when the data of the NALU header 530 is included in the TS packet 110.

The packet processor 720 may extract scalability information from only the TS packet 110 including the data of the NALU header 530 among at least one TS packet 110 having the same PID 130.

Additionally, a specific TS packet may not include scalability information. In this instance, the packet processor 720 may extract scalability information from a TS packet of a previous time that 1) includes scalability information and that 2) is located closest to the specific TS packet, among the at least one TS packet 110 having the same PID 130 as the specific TS packet, and may use the extracted scalability information as scalability information of the specific TS packet.

Technical information according to the embodiments described above with reference to FIGS. 1 to 6 may equally be applied to the present embodiment and accordingly, a further description thereof will be omitted herein.

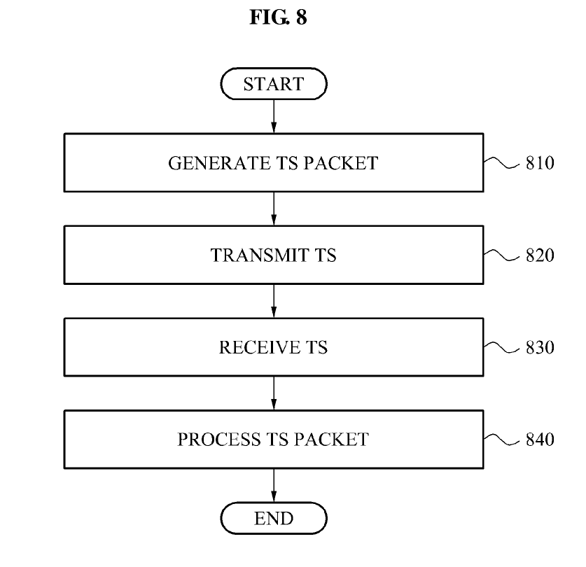

FIG. 8 is a flowchart of a streaming service method 800 according to an embodiment.

The streaming service method 800 may be used to process the MPEG-2 TS of FIG. 6.

In operation 810, the TS packet 110 may be generated, for example, by the packet generator 610 of the streaming server 600.

In operation 820, the TS 100 generated using the TS packet 110 may be transmitted, for example, by the transmitter 620 of the streaming server 600.

The TS 100 may include a scalable video stream, and the header of the TS packet 110 may include scalability information of the scalable video stream.

In operation 830, the TS 100 may be received, for example, by the receiver 710 of the streaming client 700.

In operation 840, the TS packet 110 in the TS 100 may be processed, for example, by the packet processor 720 of the streaming client 700.

Technical information according to the embodiments described above with reference to FIGS. 1 to 7 may equally be applied to the present embodiment and accordingly, a further description thereof will be omitted herein.

An existing MPEG-2 system may be extended through the streaming server 600, the streaming client 700, and the streaming service method 800. Additionally, a scalable video multiplexed by the TS packet 110 may be adapted in a form suitable for various terminal performances, a network status, a user preference, and the like. The TS packet 110 may be efficiently extracted from the TS 100.

Hereinafter, an apparatus and method for providing a scalable video and multi-view video in MPEG Media Transport (MMT) will be described. The embodiments or examples described above with reference to FIGS. 1 through 8 may be applied to MMT. For example, the MPEG-2 TS of FIGS. 1 through 8 may be replaced by MMT or an MMT stream.

Scalable video information and multi-view video information may be inserted into a Media Fragment Unit Header (MFUH) that is a smallest unit forming an MMT packet.

Due to a layer_info_flag indicating whether information associated with a scalable video and multi-view video exists, layer information may be selectively provided through the MFUH.

A scalable video and multi-view video may be divided and included within an MFU payload. Accordingly, layer type information of each video may be classified, and scalable video information, multi-view video information, and scalable multi-view video information may be provided.

Information provided in association with a scalable video may include spatial scalability information, temporal scalability information, and quality scalability information. Additionally, priority information of layers for the scalable video may be provided.

Information provided in association with a multi-view video may include view information, and temporal scalability information. Additionally, priority information of layers for the multi-view video may be provided. In addition, flag information allowing interview prediction, that is, a characteristic of the multi-view video, and anchor picture flag information used for a random access may be provided.

Information provided in association with a scalable multi-view video may include view information, as well as, combined scalability information, such as spatial-view scalability, and the like.

By using the above-described information, an MMT packetized scalable video and a multi-view video may be efficiently adapted to terminals with various terminal performances, various network characteristics, a specific user preference, and the like.

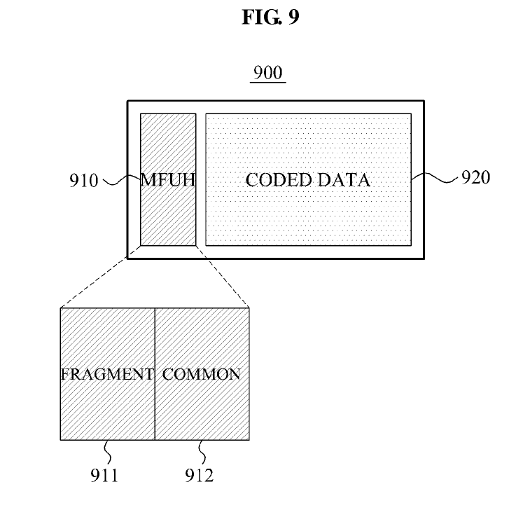

Hereinafter, an operation of generating an MMT packet will be described with reference to FIGS. 9 through 18.

FIG. 9 illustrates an MFU according to an embodiment.

An MFU 900 may be briefly referred to as a media fragment.

The MFU 900 may be a generic container, independent of a specific media codec. The MFU 900 may include coded media data. The coded media data may be independently consumed by a media decoder. The coded media data may be briefly referred to as coded data. The MFU 900 may include a complete or partial Access Unit (AU), and information that may be utilized by delivery layers.

The AU may be a smallest data entity to which timing information may be attributed.

The MFU 900 may define a format to encapsulate a fragment of an AU for the delivery layers to perform adaptive delivery at a boundary of MFUs. The MFU 900 may be used to carry some types of coded media so that fragments may be independently decoded or discarded.

The MFU 900 may include an MFUH 910, and coded data 920.

The MFUH 910 may include a fragment 911, and a common 912. The MFU 900 may include an identifier to distinguish one MFU from another MFU, and may include generalized relationship information among MFUs within a single AU. The fragment 911 may be the identifier, and the common 912 may be the generalized relationship information.

A fragment-generating encoder may generate the MFU 900.

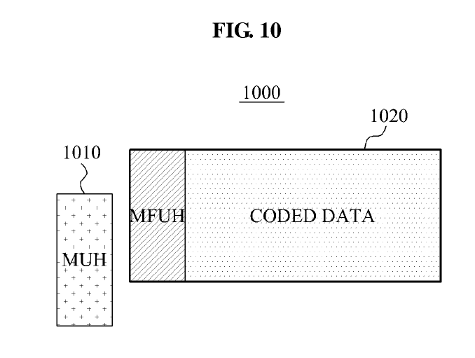

FIG. 10 illustrates a single M-unit case of an M-unit according to an embodiment.

The M-unit may be a generic container format, independent of a specific codec. The M-unit may carry one or more AUs. The M-unit may include one or more MFUs. The M-unit may include either timed data or non-timed data. The M-unit may include data of the MFU 900 and additional information. The additional information may be, for example, a timestamp for synchronization. The M-unit may be a data entity for processing by MMT encapsulation functions.

The timed data may be a data element that is associated with a specific time for decoding and presentation. The non-timed data may be a data element that is consumed at a non-specified time. The non-timed data may have a timing range when data is available to be executed or launched.

An M-unit 1000 of a single M-unit case may include an M-Unit Header (MUH) 1010, and the MFU 900.

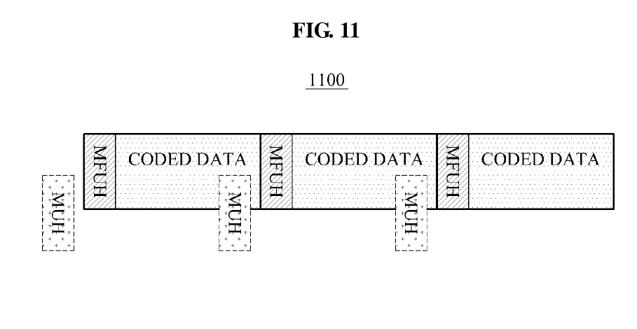

FIG. 11 illustrates a fragmented M-unit case of an M-unit according to an embodiment.

An M-unit 1100 of a fragmented M-unit case may include one or more MFUs. In FIG. 11, the M-unit 1100 of the fragmented M-unit case may include three MFUs, and three MUHs that respectively correspond to the three MFUs.

An M-unit generation encoder may generate an M-unit.

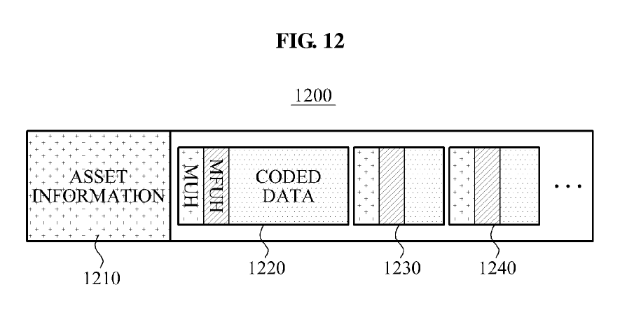

FIG. 12 illustrates an MMT asset according to an embodiment.

An MMT asset 1200 may be a logical data entity that includes one or more Media Processing Units (MPUs) with the same MMT Asset ID. The MMT asset 1200 may be a largest data unit for which the same composition information and transport characteristics are applied.

An MPU may be a generic container for timed data or non-timed data, independent of a specific media codec. The MPU may include one or more AUs for timed data. The MPU may include a portion of data without AU boundaries for non-timed data. The MPU may include additional delivery and consumption related information. The MPU may be a coded media data unit that may be completely and independently processed. In this instance, processing may mean encapsulation into an MMT package, or packetization for delivery.

The MMT asset 1200 may be a data entity that includes one or more M-units. The MMT asset 1200 may be a data unit for which composition information and transport characteristics are defined.

The MMT asset 1200 may include asset information 1210, and one or more M-units. The one or more M-units may include a first M-unit 1220, a second M-unit 1230, and a third M-unit 1230. Each of the one or more M-units may be the M-unit 1000 of the single M-unit case, or the M-unit 1100 of the fragmented M-unit case. The MMT asset 1200 may include asset information 1210, and one or more MFUs. Each of the one or more MFUs may be the MFU 900.

The asset information 1210 may be asset-specific information. The asset information 1210 may not be transmitted in streaming.

The asset information 1210 may be used for capability exchange and/or (re)allocation of resources in underlying layers.

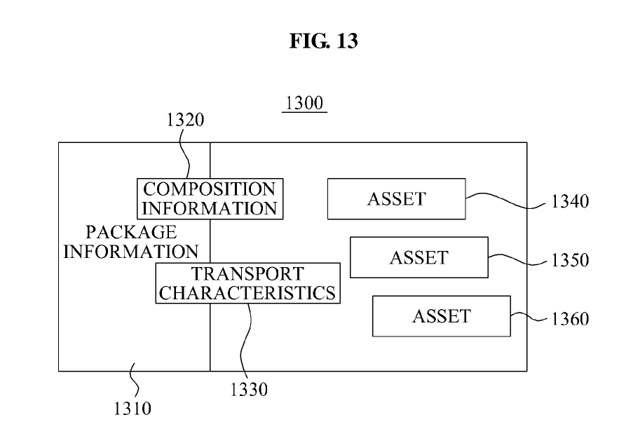

FIG. 13 illustrates an MMT package according to an embodiment.

An MMT package 1300 may be a logically structured collection of data. The MMT package 1300 may include one or more MMT Assets, MMT composition information, MMT asset delivery characteristics, and descriptive information.

The MMT asset delivery characteristics may include description about required Quality of Service (QoS) for delivery of MMT Assets. The MMT asset delivery characteristics may be represented by parameters agnostic to a specific delivery environment.

The MMT package 1300 may include package information 1310.

The MMT package 1300 may include composition information 1320. Composition information may correspond to MMT composition information. The MMT composition information may be used to describe spatial and temporal relationship among MMT assets.

The MMT package 1300 may include transport characteristics (Tx. Char.) 1330.

The MMT package 1300 may include one or more assets. Each of the one or more assets may be the MMT asset 1200 of FIG. 12. As the one or more assets, a first asset 1340, a second asset 1350, and a third asset 1360 are illustrated.

The one or more assets within the MMT package 1300 may be multiplexed, or concatenated.

The MMT package 1300 may be used for archiving. For example, the MMT package 1300 may be a unit for storage.

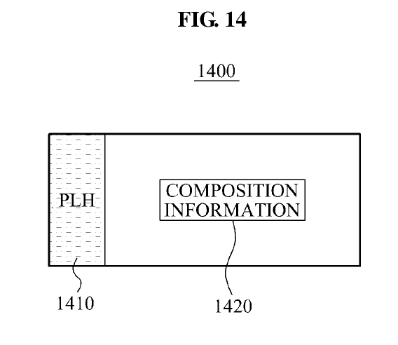

Hereinafter, an MMT PayLoad Format (MMT PL-Format) will be described with reference to FIGS. 14 through 16.

An MMT payload may be a formatted unit of data to carry an MMT package or an MMT signaling message, using either an MMT protocol or Internet application layer protocols. An Internet application layer protocol may include, for example, a Real-time Transport Protocol (RTP).

The MMT protocol may be an application layer protocol to deliver an MMT payload over an Internet Protocol (IP) network.

The MMT PL-Format may be a generic payload format to carry MMT assets and other information, for their consumption by MMT application protocols or other existing application transport protocols. For example, other existing application transport protocols may include, for example, RTPs.

The MMT PL-Format may include fragments of the MFU 900. The MMT PL-Format may also include other information, such as Application Layer Forward Error Correction (AL-FEC), together with the fragments of the MFU 900.

FIG. 14 illustrates an MMT PL-Format for a control type packet according to an embodiment.

A first MMT PL-Format 1400 for a control type packet may include a PayLoad Header (PLH) 1410, and composition information 1420. The composition information 1420 may correspond to the composition information 1320 of the MMT package 1300 of FIG. 13.

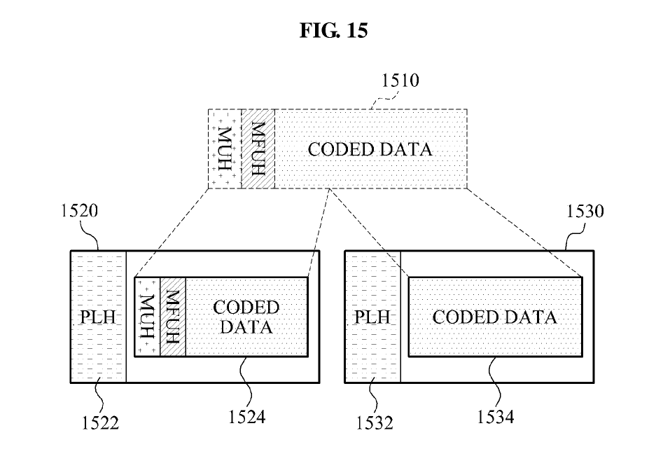

FIG. 15 illustrates an MMT PL-Format for a media type packet according to an embodiment.

Aggregation and/or fragmentation of a packet-level of an MTU 1510 may be applied to a second MMT PL-Format 1520 for a media type packet, and a third MMT PL-Format 1530 for a media type packet.

Data of the M-unit 1510 may be divided into the second MMT PL-Format 1520 and the third MMT PL-Format 1530. The M-unit 1510 may correspond to the MFU 900, the M-unit 1000 of the single M-unit case, the M-unit 1100 of the fragmented M-unit case, or the M-units of the MMT asset 1200.

The second MMT PL-Format 1520 may include a PLH 1522, and a portion 1524 of an M-unit. The portion 1524 of the M-unit may include an MUH, an MFUH, and a portion of coded data.

The third MMT PL-Format 1530 may include a PLH 1532, and a portion 1534 of an M-unit. The portion 1534 of the M-unit may include a portion of the coded data.

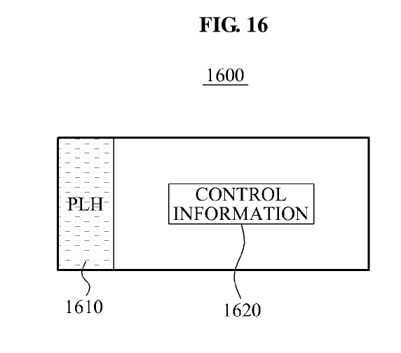

FIG. 16 illustrates an MMT PL-Format for a control type packet according to an embodiment.

A fourth MMT PL-Format 1600 for a control type packet may include a PLH 1610, and control information 1620.

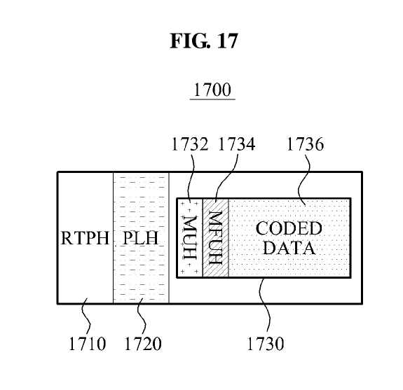

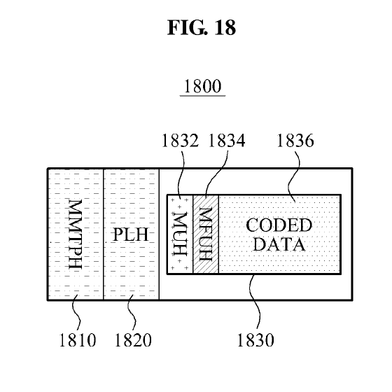

Hereinafter, an MMT packet will be described with reference to FIGS. 17 and 18.

The MMT packet may be a formatted unit of data generated or consumed by an MMT protocol.

The MMT packet may be an MMT transport packet. The MMT transport packet may be a data format used by an application transport protocol for MMT.

FIG. 17 illustrates a first MMT packet according to an embodiment.

A first MMT packet 1700 may include a Real-time Transport Protocol Header (RTPH) 1720, a PLH 1720, and a portion 1730 of an M-unit. The portion 1730 of the M-unit may correspond to the portion 1524 of FIG. 15. The portion 1730 of the M-unit may include an MUH 1732, an MFUH 1734, and coded data 1736.

The PLM 1720 and the portion 1730 of the M-unit may correspond to the second MMT PL-Format 1520 of FIG. 15. The PLM 1720 and the portion 1730 of the M-unit may be data of the second MMT PL-Format 1520.

FIG. 18 illustrates a second MMT packet according to an embodiment.

A second MMT packet 1800 may include an MMT Packet Header (MMTPH) 1810, a PLH 1820, and a portion 1830 of an M-unit. The portion 1830 of the M-unit may correspond to the portion 1524 of FIG. 15. The portion 1830 of the M-unit may include an MUH 1832, an MFUH 1834, and coded data 1836.

The PLM 1820 and the portion 1830 of the M-unit may correspond to the second MMT PL-Format 1520 of FIG. 15. The PLM 1820 and the portion 1830 of the M-unit may be data of the second MMT PL-Format 1520.

An MMT packet may be generated for data or units described above with reference to FIGS. 9 through 18. FIGS. 9 through 18 illustrate a packetization process of generating the MMT packet 920 including the MFU 900. The MFU 900 may be a smallest unit forming an MMT packet.

An MMT packet may be generated for archiving or streaming. When video information including a plurality of layers, such as a scalable video and multi-view video, exists, the MFU 900 may be a unit to perform payload a unit of each of the layers. A header of the MFU 900 may include header information included in a NALU header of a scalable video or multi-view video.

In a payload of the MFU 900, data of a scalable video and multi-view video may be divided and included. Additionally, in the payload of the MFU 900, data of a scalable multi-view video may be divided and included.

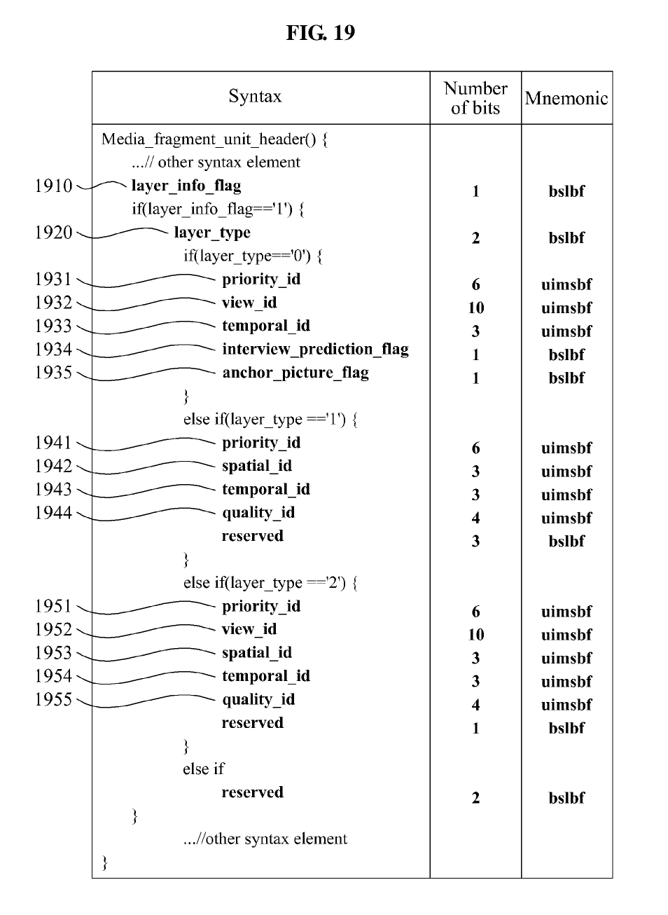

FIG. 19 illustrates a syntax to provide scalable video or multi-view video information according to an embodiment.

The header of the MFU 900 of MMT may provide layer information for MVC and SVC encoded data. In addition, combined scalability using a view point of a multi-view video and temporal, spatial, and quality of a scalable video may also be introduced.

The MMT may use a case document. The case document may include a case scenario on adaptive contents consumption. The adaptive contents consumption may be based on a terminal capability, a network condition and/or user preferences.

Hereinafter, a header field of the MFU 900 for efficient view point adaptation and for scalable layered video adaption will be described. View point adaptation information of MVC and scalable layer information of SVC may be used independently, or may be used in a combined mode for scalable multi-view video.

In MMT, the MFU 900 may be a smallest decodable data unit. The MFU 900 may be an E.3 layer. A syntax of FIG. 10 may be applied to an E.3 layer header field. An E.3 layer header may include view point information. Additionally, the E.3 layer header may provide temporal, spatial, and quality layer information of layered coded data.

Data of the syntax of FIG. 19 may provide at least one of information of a scalable video and information of a multi-view video. The data of the syntax may be selectively included in the header of the MFU 900.

At least one of the information of the scalable video and the information of the multi-view video may be selectively included in the header of the MFU 900. In other words, the header of the MFU 900 may include at least one of flags of a syntax that will be described below. The MFU 900 may be the smallest unit forming an MMT packet.

A layer_info_flag 1910 may be a flag indicating whether a scalable video or multi-view video is included in the payload of the MFU 900. The layer_info_flag 1910 with a value of “1” may indicate that the payload includes layered video data encoded with MVC, SVC, or combined MVC/SVC.

When the layer_info_flag 1910 exists, a scalable video, a multi-view video, or a scalable multi-view video may be distinguished through a layer_type 1920.

When the layer_info_flag has a value of “1,” a layer_type may indicate a type of layered data in the payload of the MFU 900, as specified in Table 1 below.

TABLE 1

| Value | Layer_type |
|---|---|
| 0 | Multi-view video |
| 1 | Scalable video |
| 2 | Combined scalability video |
| 3 | Reserved |

When the layer_type 1920 has a value of “0,” information regarding a multi-view video may be provided. When the layer_type 1920 has a value of “1,” information regarding a scalable video may be provided. When the layer_type 1920 has a value of “2,” information regarding a scalable multi-view video may be provided.

Grammatical elements for a multi-view video provided when the layer_type 1920 has a value of “0” will be described below. For example, when the layer_type 1920 has a value of “0,” information regarding the multi-view video may be provided below.

The information regarding the multi-view video may include a priority_id 1931 indicating a priority of a multi-view video layer included in the current MFU 900, a view_id 1932 indicating a unique ID of a view of the multi-view video, a temporal_id 1933, an interview_prediction_flag 1934, and an anchor_picture_flag 1935 for a random access.

Hereinafter, a multi-view layer or a layer may refer to a multi-view layer of the multi-view video. The multi-view video may be an MVC video.

The priority_id 1931 may be priority information of each layer included in an MFU payload of the multi-view video.

The priority_id 1931 may indicate a priority of a multi-view layer included in the current MFU 900. A lower value of the priority_id 1931 may indicate a higher priority.

The view_id 1932 may indicate a unique view ID of an MVC video.

The temporal_id 1933 may indicate a temporal level of an MVC video.

The interview_prediction_flag 1934 with a value of “1” may indicate that a current view component is predictable by other view components in a current AU. A view component may be a coded representation of a view in a single AU.

The anchor_picture_flag 1935 with a value of “1” may indicate that a current AU is an anchor AU.

The interview_prediction_flag 1934 may indicate whether a current view component is predictable by other view components in a current AU. The interview_prediction_flag 1934 may allow interview prediction.

The anchor_picture_flag 1935 may be used for a random access to the MVC video.

Grammatical elements of a multi-view video provided when the layer_type 1920 has a value of “1” will be described below. For example, when the layer_type 1920 has a value of “1,” information regarding the scalable video may be provided below. Hereinafter, a scalable layer or a layer may refer to a scalable layer of the scalable video. The scalable video may be an SVC video.

The information regarding the scalable video may include a priority_id 1941 indicating a priority of a scalable video layer included in the current MFU 900, a spatial_id 1942, a temporal_id 1943, and a quality_id 1944.

The priority_id 1941 may be priority information of each layer included in an MFU payload of the scalable video.

The priority_id 1941 may indicate a priority of a scalable layer included in the current MFU 900. A lower value of the priority_id 1941 may indicate a higher priority.

The spatial_id 1942 may indicate a spatial level of an SVC video.

The temporal_id 1943 may indicate a temporal level of an SVC video.

The quality_id 1944 may indicate a quality level of an SVC video.

Grammatical elements of a scalable multi-view video provided when the layer_type 1920 has a value of “2” will be described below. For example, when the layer_type 1920 has a value of “2,” information regarding the scalable multi-view video may be provided below. The information regarding the scalable multi-view video may be provided as combined scalability information.

The information regarding the scalable multi-view video may include a priority_id 1951 indicating a priority of a scalable multi-view video layer included in the current MFU 900, a view_id 1952, a spatial_id 1953, a temporal_id 1954, and a quality_id 1955.

The priority_id 1951 may indicate a priority of the scalable multi-view video included in the current MFU 900. A lower value of the priority_id 1951 may indicate a higher priority.

The view_id 1952 may indicate a unique view ID of the scalable multi-view video.

The spatial_id 1953 may indicate a spatial level of the scalable multi-view video.

The temporal_id 1954 may indicate a temporal level of the scalable multi-view video.

The quality_id 1955 may indicate a quality level of the scalable multi-view video.

Usage of the priority_id 1931, the priority_id 1941, and the priority_id 1951 may be respectively defined by an application.

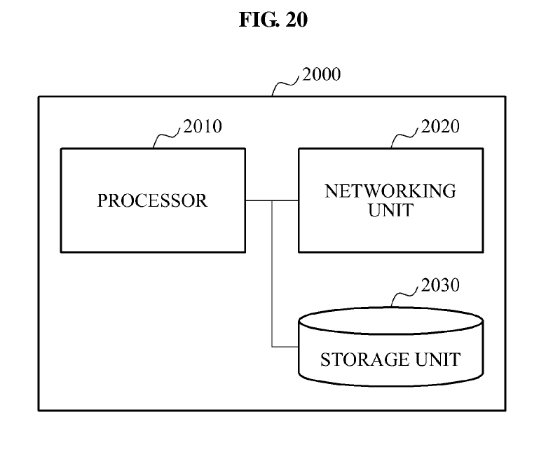

FIG. 20 is a diagram illustrating a structure of a streaming server according to an embodiment.

A streaming server 2000 may include a processor 2010, a networking unit 2020, and a storage unit 2030.

The processor 2010 may correspond to the packet generator 610 described above with reference to FIG. 6. The networking unit 2020 may correspond to the transmitter 620 and the network interface unit 630 described above with reference to FIG. 6. The storage unit 2030 may correspond to the storage unit 640 described above with reference to FIG. 6.

The processor 2010 may generate a packet. The packet may be an MPEG-2 TS packet or an MMT packet. The networking unit 2020 may transmit a stream using the generated packet. The stream may be an MPEG-2 TS or an MMT stream. The MMT stream may use an MMT packet.

The stream may include at least one of a multi-view video stream, a scalable video stream, and a multi-view scalable video stream.

A header of the packet may include scalability information of the scalable video stream. The scalable video stream may be divided and included in the payload of the packet.

The scalability information may be included in transport private data of the header. The transport private data may be included in an optional field in an adaptation field of the header. The header may include a scalability information flag indicating whether the scalability information exists, and a view information flag indicating whether view information of the scalable video stream exists.

The header may include a transport private data flag indicating whether the scalability information flag and the view information flag exist.

The scalability information may include spatial scalability information of the scalable video, temporal scalability information of the scalable video, and quality scalability information of the scalable video.

The view information may be included in the transport private data of the header.

The processor 2010 may generate view information using second view information in a NALU header of an MVC.

The processor 2010 may generate scalability information using second scalability information in a NALU header of a SVC.

The processor 2010 may generate scalability information only when data of the NALU header is included in a stream packet.

The processor 2010 may generate scalability information in only a stream packet including the data of the NALU header, among one or more stream packets having the same PID.

The processor 2010 may include a scalability information inserter to insert scalability information into stream packet.

The processor 2010 may generate an MMT packet.

The processor 2010 may generate an MFU, an M-unit, an MMT asset, an MMT package, and an MMT packet that have been described above with reference to FIGS. 9 through 18.

The processor 2010 may store, in the storage unit 2030, the MFU, the M-unit, the MMT asset, the MMT package, and the MMT packet.

The networking unit 2020 may transmit an MMT stream using an MMT packet. The MMT stream may include one or more MMT packets. An MMT packet may include at least one of a multi-view video, a scalable video and a scalable multi-view video.

The networking unit 2020 may transmit a stream to a streaming client 2100, such as a video player.

An MFU in an MMT packet may include at least one of a scalable video, a multi-view video and a scalable multi-view video.

An MFU in an MMT packet may include at least one of a scalable video, a multi-view video and a scalable multi-view video.

A header of the MFU may include a priority ID. The priority ID may indicate a priority of a multi-view layer of the multi-view video included in the MFU.

The header of the MFU may include a view ID, an interview prediction flag, and an anchor picture flag. The view ID may indicate a unique ID of the multi-view video. The interview prediction flag may indicate whether a current view component is predictable by other view components in a current AU. The anchor picture flag may be used for a random access to the multi-view video.

The priority ID may indicate a priority of a scalable layer of the scalable video included in the MFU. The header of the MFU may include a spatial ID, a temporal ID, and a quality ID. The spatial ID may indicate a spatial level of the scalable video. The temporal ID may indicate a temporal level of the scalable video.

The quality ID may indicate a quality level of the scalable video.

The priority ID may indicate a priority of the multi-view scalable video included in the MFU. The header of the MFU may include a view ID, a spatial ID, a temporal ID, and a quality ID. The view ID may indicate a unique ID of the scalable multi-view video. The spatial ID may indicate a spatial level of the scalable multi-view video. The temporal ID may indicate a temporal level of the scalable multi-view video. The quality ID may indicate a quality level of the scalable multi-view video.

The header of the MFU may include a layer information flag. The layer information flag may indicate whether information regarding at least one of the scalable video, the multi-view video and the scalable multi-view video exists. The header may include information of a layer type of at least one of the scalable video, the multi-view video and the scalable multi-view video exists, through the layer information flag.

The header may include at least one of information of the multi-view video, information of the scalable video, and information of the multi-view scalable video, based on the information of the layer type. At least one of the scalable video, the multi-view video and the scalable multi-view video may be divided and included in an to MFU payload in the MMT packet.

Technical information according to the embodiments described above with reference to FIGS. 1 to 19 may equally be applied to the present embodiment and accordingly, a further description thereof will be omitted herein.

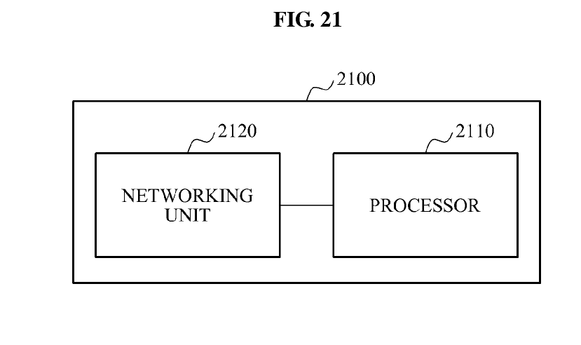

FIG. 21 is a diagram illustrating a structure of a streaming client according to an embodiment.

The streaming client 2100 may include a processor 2110 and a networking unit 2120. The networking unit 2120 may correspond to the receiver 710 of FIG. 7. The processor 2110 may correspond to the packet processor 720 of FIG. 7.

The networking unit 2120 may receive a stream. The stream may be an MPEG-2 TS, or an MMT stream. The MMT stream may use an MMT packet.

The processor 2110 may process a packet of the stream. The packet may be an MPEG-2 TS packet, or an MMT packet.

The stream may include a scalable video stream. A header of a stream packet may include scalability information of the scalable video stream.

The processor 2110 may determine whether the scalability information is included and view information of the scalable video stream is included in the packet, based on a scalability information flag and a view information flag that are included in the header.

The processor 2110 may generate, based on the scalability information, scalability information in a NALU header of SVC.

The processor 2110 may extract the scalability information, only when data of the NALU header is included in the stream packet.

The processor 2110 may extract the scalability information from only a stream packet including the data of the NALU header among one or more stream packets having the same PID.

The processor 2110 may extract scalability information of a packet from a packet of a previous time that includes scalability information and that is located closest to the packet, among the one or more stream packets having the same PID.

The networking unit 2120 may receive an MMT stream.

The processor 2110 may process an MFU, an M-unit, an MMT asset, an MMT package, and an MMT packet that have been described above with reference to FIGS. 9 through 18. The processor 2110 may play back content of the MMT stream, by processing the MFU, the M-unit, the MMT asset, the MMT package, and the MMT packet.

Technical information according to the embodiments described above with reference to FIGS. 1 to 20 may equally be applied to the present embodiment and accordingly, a further description thereof will be omitted herein.

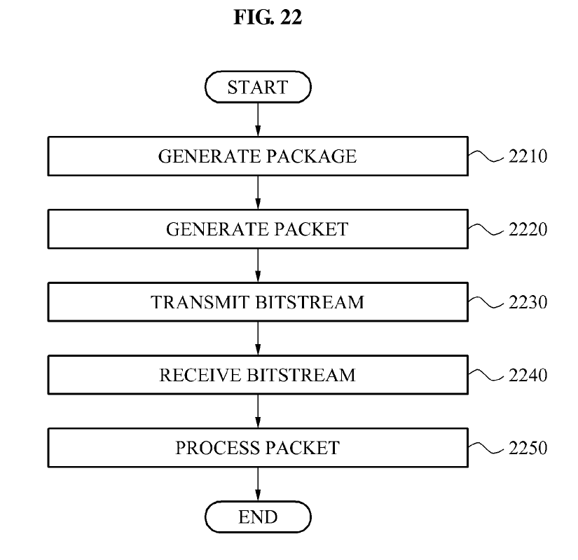

FIG. 22 is a flowchart of a streaming service method according to an embodiment.

In operation 2210, the processor 2010 of the streaming server 2000 may generate a package. The package may be an MMT package.

In operation 2220, the processor 2010 may generate a packet. The packet may be an MMT packet.

In operation 2230, the networking unit 2020 of the streaming server 2000 may transmit a stream. The stream may be a bitstream. The stream may be an MMT stream.

In operation 2240, the networking unit 2120 of the streaming client 2100 may receive the stream.

In operation 2250, the processor 2110 of the streaming client 2100 may process a packet in the stream.

Technical information according to the embodiments described above with reference to FIGS. 1 to 21 may equally be applied to the present embodiment and accordingly, a further description thereof will be omitted herein.

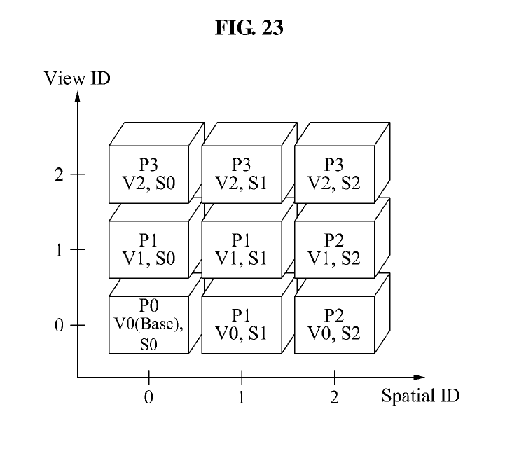

FIG. 23 illustrates combined scalability according to an embodiment.

In FIG. 23, an x-axis may represent a spatial ID, and a y-axis may represent a view ID. V0 may represent a base view.

In FIG. 23, MVC may provide three views, and SVC may provide three level spatial scalability. FIG. 23 illustrates an example of combined scalability in terms of view and spatial scalabilities. In FIG. 23, a priority_id may have values of P0 to P3. The values of the priority_id may be arbitrarily assigned by an operator with a predefined priority assigning policy. A combined scalability option may provide more flexible adaptation scenarios for users in terms of a screen size and view point.

The method according to the embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A streaming server, comprising:
a processor to generate a Moving Picture Experts Group (MPEG) Media Transport (MMT) packet; and
a networking unit to transmit an MMT stream using the MMT packet,
wherein the MMT packet comprises at least one of a multi-view video, a scalable video, and a scalable multi-view video.

2. The streaming server of claim 1, wherein a Media Fragment Unit (MFU) in the MMT packet comprises at least one of the multi-view video, the scalable video, and the scalable multi-view video.

3. The streaming server of claim 2, wherein a header of the MFU comprises a priority identifier (ID), and
wherein the priority ID indicates a priority of a multi-view layer of the multi-view video included in the MFU.

4. The streaming server of claim 3, wherein the header of the MFU comprises a view ID, an interview prediction flag, and an anchor picture flag,
wherein the view ID indicates a unique ID of the multi-view video,
wherein the interview prediction flag indicates whether a current view component is predictable by other view components in a current Access Unit (AU), and
wherein the anchor picture flag is used for a random access to the multi-view video.

5. The streaming server of claim 2, wherein the header of the MFU comprises a priority ID, and
wherein the priority ID indicates a priority of a scalable layer of the scalable video included in the MFU.

6. The streaming server of claim 5, wherein the header of the MFU comprises a spatial ID, a temporal ID, and a quality ID,
wherein the spatial ID indicates a spatial level of the scalable video,
wherein the temporal ID indicates a temporal level of the scalable video, and
wherein the quality ID indicates a quality level of the scalable video.

7. The streaming server of claim 2, wherein the header of the MFU comprises a priority ID, and
wherein the priority ID indicates a priority of the multi-view scalable video included in the MFU.

8. The streaming server of claim 7, wherein the header of the MFU comprises a view ID, a spatial ID, a temporal ID, and a quality ID,
wherein the view ID indicates a unique ID of the scalable multi-view video,
wherein the spatial ID indicates a spatial level of the scalable multi-view video,
wherein the temporal ID indicates a temporal level of the scalable multi-view video, and
wherein the quality ID indicates a quality level of the scalable multi-view video.

9. The streaming server of claim 2, wherein the header of the MFU comprises a layer information flag,
wherein the layer information flag indicates whether information regarding at least one of the scalable video, the multi-view video and the scalable multi-view video exists, and
wherein the header comprises information of a layer type of at least one of the scalable video, the multi-view video and the scalable multi-view video exists, through the layer information flag.

10. The streaming server of claim 9, wherein the header comprises at least one of information of the multi-view video, information of the scalable video, and information of the multi-view scalable video, based on the information of the layer type.

11. The streaming server of claim 1, wherein at least one of the scalable video, the multi-view video and the scalable multi-view video is divided and included in an MFU payload in the MMT packet.

12. A streaming service method, comprising:
generating a Moving Picture Experts Group (MPEG) Media Transport (MMT) packet; and
transmitting an MMT stream using the MMT packet,
wherein the MMT packet comprises at least one of a multi-view video, a scalable video, and a scalable multi-view video.

13. A streaming client, comprising:
a networking unit to receive a Moving Picture Experts Group (MPEG) Media Transport (MMT) stream; and
a processor to process an MMT packet in the MMT stream,
wherein the MMT packet comprises at least one of a multi-view video, a scalable video, and a scalable multi-view video.

14. The streaming client of claim 13, wherein a Media Fragment Unit (MFU) in the MMT packet comprises at least one of the multi-view video, the scalable video, and the scalable multi-view video.

15. The streaming client of claim 14, wherein a header of the MFU comprises a priority identifier (ID), and
wherein the priority ID indicates a priority of a multi-view layer of the multi-view video included in the MFU.

16. The streaming client of claim 15, wherein the header of the MFU comprises a view ID, an interview prediction flag, and an anchor picture flag,
wherein the view ID indicates a unique ID of the multi-view video,
wherein the interview prediction flag indicates whether a current view component is predictable by other view components in a current Access Unit (AU), and
wherein the anchor picture flag is used for a random access to the multi-view video.

17. The streaming client of claim 14, wherein the header of the MFU comprises a priority ID, and
wherein the priority ID indicates a priority of a scalable layer of the scalable video included in the MFU.

18. The streaming client of claim 17, wherein the header of the MFU comprises a spatial ID, a temporal ID, and a quality ID,
wherein the spatial ID indicates a spatial level of the scalable video,
wherein the temporal ID indicates a temporal level of the scalable video, and
wherein the quality ID indicates a quality level of the scalable video.

19. The streaming client of claim 14, wherein the header of the MFU comprises a priority ID, and
wherein the priority ID indicates a priority of the multi-view scalable video included in the MFU.

20. A streaming service method, comprising:
receiving a Moving Picture Experts Group (MPEG) Media Transport (MMT) stream; and
processing an MMT packet in the MMT stream,
wherein the MMT packet comprises at least one of a multi-view video, a scalable video, and a scalable multi-view video.
